(19) United States
(12) Patent Application Publication
(10) Pub. No.: US 2006/0233250 A1
(43) Pub. Date: Oct. 19, 2006

(54) Method and apparatus for encoding and decoding video signals in intra-base-layer prediction mode by selectively applying intra-coding

(75) Inventors: Sang-chang Cha, Hwaseong-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/402,860

(22) Filed: Apr. 13, 2006

Related U.S. Application Data
(60) Provisional application No. 60/670,700, filed on Apr. 13, 2005.
(60) Provisional application No. 60/672,547, filed on Apr. 19, 2005.

(30) Foreign Application Priority Data
Jun. 21, 2005 (KR) 10-2005-0053661

(51) Int. Cl. H04N 7/12

(52) U.S. Cl. 375/240.12

(57) ABSTRACT

A method and apparatus for encoding and decoding macroblocks in an intra-base layer prediction mode by selectively applying intra-coding are provided. The method includes the steps of calculating a difference between an input frame and a base layer frame calculated from the input frame and obtaining residual signals, converting the residual signals using an intra-coding method, and generating an enhancement layer frame including the converted residual signals.

### CROSS-REFERENCE TO RELATED APPLICATIONS

This application claims priority from Korean Patent Application No. 10-2005-0053661 filed on Jun. 21, 2005, and U.S. Provisional Patent Application Nos. 60/670,700 and 60/672,547 filed on Apr. 13, 2005 and Apr. 19, 2005, respectively, the whole disclosures of which are hereby incorporated herein by reference.

### BACKGROUND OF THE INVENTION

1. Field of the Invention

The present invention relates generally to a method and apparatus for encoding and decoding macroblocks in an intra-base-layer prediction mode by selectively applying intra-coding.

2. Description of the Related Art

As information and communication technology, including the Internet, develops, image-based communication as well as text-based communication and voice-based communication is increasing. The existing text-based communication is insufficient to satisfy consumers' various demands. Therefore, the provision of multimedia services capable of accommodating various types of information, such as text, images and music, is increasing. Since multimedia data files are large, they require high-capacity storage media and a broad bandwidth at the time of transmission. Therefore, to transmit multimedia data, including text, images and audio, it is essential to compress the data.

The fundamental principle of data compression is to eliminate data redundancy. Data can be compressed by eliminating spatial redundancy, such as the case where the same color or object is repeated in an image, temporal redundancy, such as the case where there is little change between neighboring frames or the same sound is repeated, or perceptual/visual redundancy, which takes into account human insensitivity to high frequencies. In a general coding method, temporal redundancy is eliminated by temporal filtering based on motion compensation, and spatial redundancy is eliminated by a spatial transform.

In order to transmit multimedia data after the redundancy has been removed, transmission media are necessary. Performance differs according to the transmission medium. Currently used transmission media have various transmission speeds ranging from the speed of an ultra high-speed communication network, which can transmit data at a transmission rate of several tens of megabits per second, to the speed of a mobile communication network, which can transmit data at a transmission rate of 384 Kbits per second. In these environments, a scalable video encoding method, which can support transmission media having a variety of speeds or can transmit multimedia at a transmission speed suitable for each transmission environment, is required. Also, the size of a screen, such as the aspect ratio (e.g., 4:3 or 16:9) may vary according to the size or characteristics of a reproduction apparatus at the time of reproduction of the multimedia data.

Such a scalable video coding method refers to a coding method that allows a video resolution, frame rate, signal-to-noise ratio (SNR), and other parameters to be adjusted by truncating part of an already compressed bitstream in conformity with surrounding conditions, such as the transmission bit rate, transmission error rate, and system source. With regard to the scalable video encoding method, standardization is in progress in Moving Picture Experts Group-21 (MPEG-21) Part 10. In particular, much research into multi-layer based scalability has been carried out. For example, scalability can be implemented in such a way that multiple layers, including a base layer, a first enhancement layer and a second enhancement layer, are provided, and respective layers are constructed to have different resolutions, such as a Quarter Common Intermediate Format (QCIF), a Common Intermediate Format (CIF) and a 2CIF, or different frame rates.

In the case of coding for a multiple layer, as in the case of coding for a single layer, it is necessary to obtain motion vectors (MVs) for eliminating temporal redundancy from each layer. The MVs are obtained separately for each layer and are then used, or they are obtained from a single layer and are then used for other layers (without change or after up/down-sampling). When comparing the two methods, the former case has the advantage of finding exact MVs and the disadvantage that the MVs generated for each layer act as overhead. In the former case, a goal is to more efficiently eliminate redundancy between the MVs for each layer.

FIG. 1 is a diagram showing an example of a conventional scalable video codec using a multi-layer structure. First, a base layer is defined as a layer having a QCIF and a frame rate of 15 Hz, a first enhancement layer is defined as a layer having a CIF and a frame rate of 30 Hz, and a second enhancement layer is defined as a layer having Standard Definition (SD) format and a frame rate of 60 Hz. If a 0.5 Mbps CIF stream is desired, a bitstream may be truncated and transmitted to reach a bit rate of 0.5 Mbps based on a CIF_{—}30 Hz_{—}0.7 Mbps first enhancement layer. In this manner, spatial scalability, temporal scalability and SNR scalability can be implemented.

As shown in FIG. 1, with regard to, for example, frames 10, 20 and 30, which have an identical temporal location and correspond to different layers, it can be assumed that the images thereof will be similar. Accordingly, a method of predicting texture of a current layer based on the texture of a lower layer (directly or after up-sampling), and encoding the difference between the predicted value and the actual value of the texture of a current layer is well known. In “Scalable Video Model 3.0 of ISO/IEC 21000-13 Scalable Video Coding” (hereinafter referred to as “SVM 3.0”), the method is defined as intra-Base-Layer (BL) prediction.

In the SVM 3.0 described above, a method of predicting a current block using correlation between a current block and a lower layer block is adopted in addition to inter-prediction and directional intra-prediction used in the existing H.264 digital video codec standard protocol to perform prediction on a block and macroblocks that constitute the current frame. Such a prediction method is called “intra-BL prediction,” and a mode of performing encoding using the prediction is called “intra-BL mode.”

FIG. 2 is a schematic diagram illustrating the three prediction methods; it shows case (1) where intra-prediction is performed on an arbitrary macroblock 14 of a current frame 11, case (2) where inter-prediction is performed using the current frame 11 and a frame 12 existing at a different temporal location different than that of the current frame 11, and case (3) where intra-BL prediction is performed using texture data for region 16 of a base layer frame 13 corresponding to a macroblock 14.

In the above-described scalable video coding standard, an advantageous method is selected from the three prediction methods and is used on a macroblock basis.

FIG. 3 is a diagram illustrating an intra-BL prediction method, which is one of the three prediction methods. Since coding is performed with reference to the macroblock 22 of a base layer frame, a macroblock 24, which is constructed from residual signals obtained by calculating the difference between an original macroblock 21 and the macroblock 22 of the base layer frame, is encoded. In this case, the respective residual signals of sub-blocks constituting each macroblock can be obtained. This is similar to an inter-coding method in that residuals between two frames are obtained. That is, in FIG. 3, the residual signals, which are obtained by calculating differences between the sub-blocks 25 of the original macroblock 21 and the sub-blocks 26 of the macroblock 22 of the base layer frame, construct the sub-blocks 28 of the macroblock 24 for which intra-BL prediction is used.

However, since sub-blocks of the macroblock 24 that uses, intra-BL prediction exist in a single macroblock, a uniform similarity between the residual signals of the sub-blocks exists. Accordingly, in the case of intra-BL prediction it is necessary to calculate the differences in the same macroblock, and a method and apparatus for increasing a compression rate using the similarity between the residual signals of sub-blocks are required.

### SUMMARY OF THE INVENTION

Accordingly, the present invention has been made keeping in mind the above problems occurring in the prior art, and an aspect of the present invention increases a compression rate using the similarity existing between pieces of information of sub-blocks within a macroblock that is encoded by intra-BL prediction.

Another aspect of the present invention increases a compression rate using an intra prediction method at the time of compressing video information in an intra-BL mode.

Exemplary embodiments of the present invention provide methods of encoding video signals in intra-BL prediction mode by selectively applying intra coding in a multilayer-based video encoder, the method including: calculating the difference between an input frame and a base layer frame calculated from the input frame and obtaining residual signals; converting the residual signals using an intra coding method; and generating an enhancement layer frame including the converted residual signals.

In addition, exemplary embodiments of the present invention provide methods of decoding video signals in intra-BL prediction mode by selectively applying intra coding in a multilayer-based video decoder, the method including: receiving a base layer frame and an enhancement layer frame; performing an inverse transform when the residual signals of the enhancement layer frame are encoded using an intra coding method; and performing restoration by adding the inversely transformed residual signals to the image signals of the base layer frame.

In addition, exemplary embodiments of the present invention provide an encoder, which may include: a base layer encoder for generating a base layer frame from an input frame; and an enhancement layer encoder for generating an enhancement layer frame from the input frame; wherein, at the time of generating the macroblock of the enhancement layer frame, the enhancement layer encoder includes a conversion unit for performing intra coding on residual signals obtained by calculating the difference between a macroblock of the base layer, which corresponds to the macroblock of the enhancement layer frame, and the macroblock of the input frame.

In addition, exemplary embodiments of the present invention provide a decoder, which may include: a base layer decoder for restoring a base layer frame; and an enhancement layer decoder for restoring an enhancement layer frame; wherein the enhancement layer decoder performs an inverse transform on residual signals and performs restoration by adding inversely transformed residual signals to image signals of the restored base layer frame, thus restoring the image signals when the residual signals are encoded using an intra-coding method.

### BRIEF DESCRIPTION OF THE DRAWINGS

The above and other aspects, features and advantages of the present invention will be more clearly understood from the following detailed description of exemplary embodiments taken in conjunction with the accompanying drawings, in which:

FIG. 1 is a diagram showing a scalable video codec that uses a multi-layer structure;

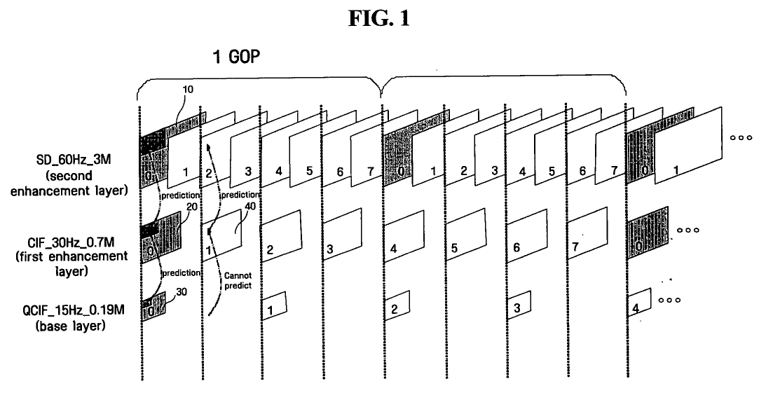

FIG. 2 is a schematic diagram illustrating three prediction methods;

FIG. 3 is a diagram illustrating the intra-BL prediction method;

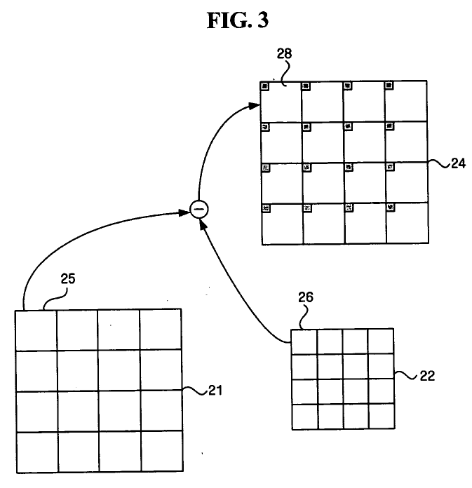

FIG. 4 is a conceptual diagram illustrating the encoding of macroblocks by intra-BL prediction according to an exemplary embodiment of the present invention;

FIG. 5 is a conceptual diagram illustrating the decoding of macroblocks by intra-BL prediction according to an exemplary embodiment of the present invention;

FIG. 6 is a block diagram showing the construction of an encoder according to an exemplary embodiment of the present invention;

FIG. 7 is a block diagram showing the construction of a decoder according to an exemplary embodiment of the present invention;

FIG. 8 is a flowchart illustrating a process of encoding a video signal according to an exemplary embodiment of the present invention;

FIG. 9 is a flowchart illustrating a process of decoding a video signal according to an exemplary embodiment of the present invention; and

FIG. 10 is an exemplary diagram illustrating a bit set unit for indicating that the method of the present invention is used when intra-BL prediction is performed according to an exemplary embodiment of the present invention.

### DESCRIPTION OF THE EXEMPLARY EMBODIMENTS

The present invention is described below with reference to drawings of block diagrams and flowcharts illustrating methods and apparatuses for encoding and decoding video signals using an intra-BL prediction mode which selectively applies intra-coding in accordance with exemplary embodiments of the present invention. It should be noted that each block of the flowchart illustrations, and combinations of blocks in the flowchart illustrations, can be implemented using computer program instructions. These computer program instructions can be provided to a processor of a general-purpose computer, a special purpose computer, or other programmable data processing apparatus to produce a machine, such that the instructions, which execute on the processor of the computer or other programmable data processing apparatus, create means for implementing the functions specified in the flowchart block or blocks.

These computer program instructions may also be stored in computer-usable or computer-readable memory that can direct a computer or other programmable data processing apparatus to function in a particular manner, such that the instructions, which are stored in the computer-usable or computer-readable memory, enables the production of a product that includes an instruction means for implementing the functions specified in the flowchart block or blocks. The computer program instructions may also be loaded onto a computer or other programmable data processing apparatus to cause a series of operation steps to be performed on the computer or other programmable apparatus to produce a computer-implemented process so that the instructions that execute on the computer or other programmable apparatus provide steps for implementing the functions specified in the flowchart block or blocks. Furthermore, each block in the flowchart illustrations may represent a module, segment, or portion of code, which comprises one or more executable instructions for implementing the specified logical function(s). It should also be noted that in some alternative implementations, the functions noted in the blocks may occur in a different order. For example, two blocks shown in succession may in fact be executed concurrently or may sometimes be executed in reverse order, depending upon the desired functionality.

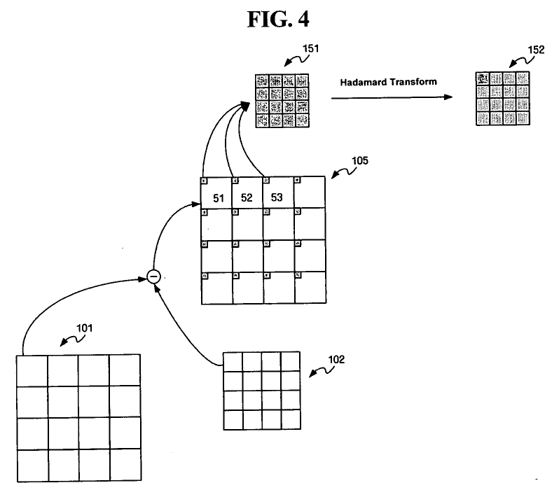

FIG. 4 is a conceptual diagram illustrating the case where a method of encoding macroblocks using intra-BL prediction according to an exemplary embodiment of the present invention is employed. The encoding of macroblocks using intra-BL prediction, as described in conjunction with FIG. 4, generates the macroblock 105 of an enhancement layer frame based on the difference between the macroblock 101 of an original video frame and the macroblock 102 of a base layer frame. In this case, respective sub-blocks are converted in order to compress information. Image signals or residual signals constituting sub-blocks can be compressed and converted using methods, such as the Discrete Cosine Transform (DCT), wavelet transform, Hadamard transform, and Fourier transform. FIG. 4 shows an example of performing the DCT transform on respective sub-blocks. In order to perform the DCT, Direct Current (DC) components are obtained from the upper-left sides of respective sub-blocks and, subsequently, Alternating Current (AC) components are obtained. The DC component of each sub-block may be regarded as a characteristic of the corresponding sub-block. However, a macroblock 105 based on intra-BL prediction is generated from the difference between the macroblock 101 of the original video frame and the macroblock 102 of the base layer frame and, as a result, the sub-blocks of the macroblock 105 have similar information values. Thus, a similarity also exists between the DC components of sub-blocks 51, 52, 53, . . . , Accordingly, compression can be performed in such a manner that the DC components are combined as indicated by reference numeral 151, and the similarity therebetween is eliminated, like the intra-coding applied in an intra-mode method. As shown in FIG. 4, results obtained by compressing the DC components using the Hadamard transform are indicated by reference numeral 152.

In contrast to the transfer of the macroblock 105, which is constructed using reference numeral 151 having DC components and AC components corresponding to the DC components as encoding results, the transfer of data 152, which is compressed more than data 105, generates a relatively high compression rate.

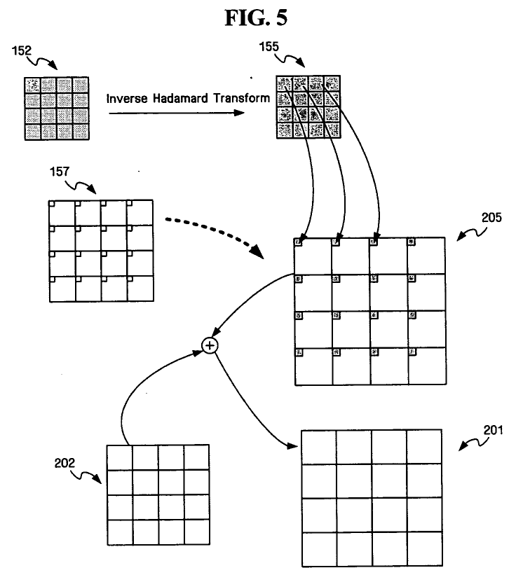

FIG. 5 is a conceptual diagram illustrating the case where a method of decoding macroblocks using intra-BL prediction according to an exemplary embodiment of the present invention is employed. Data 152, which are obtained by compressing the DC components generated in FIG. 4 using the Hadamard transform, are decompressed using an inverse Hadamard transform, thereby restoring the DC components. A macroblock 205 is generated by combining the restored DC components 155 and AC components 157. Since the macroblock 205 is a macroblock of an intra-BL mode, a macroblock 201 to be output as an image can be restored by adding the macroblock 205 to the macroblock 202 of the base layer.

The term “module” as used herein means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and may be configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The components and modules may be combined into fewer components and modules or further separated into additional components and modules. Furthermore, the components and modules may be implemented to operate one or more central processing units (CPUs) residing in a device or a secure multimedia card.

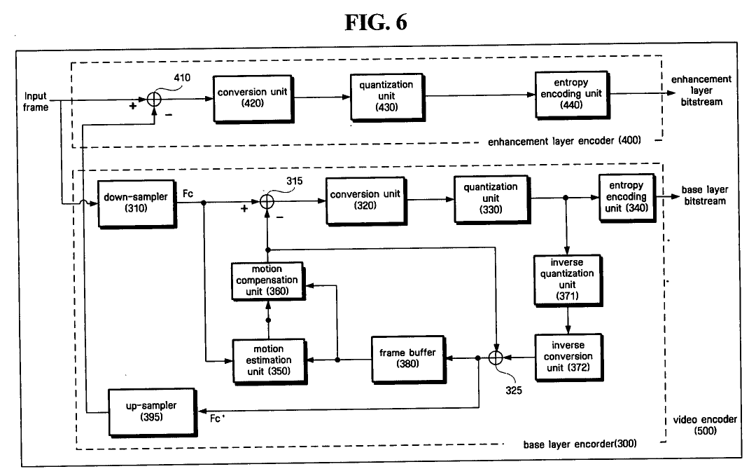

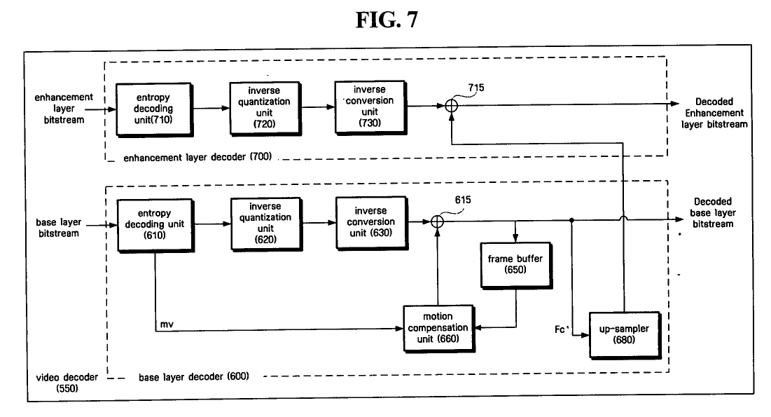

FIG. 6 is a block diagram showing the construction of an encoder according to an exemplary embodiment of the present invention. Although, in the description of FIG. 6 and in the description of FIG. 7, which will be given later, the case of using a single BL and a single enhancement layer is described, it should be apparent to those skilled in the art that the present invention can be applied between a lower layer and a current layer even if more layers are used.

The video encoder 500 may be classified into an enhancement layer encoder 400 and a BL encoder 300. First, the construction of the base layer encoder 300 is described below.

A down-sampler 310 may down-sample the input video to a resolution and frame rate suitable for the base layer, or it performs the down-sampling in accordance with a desired size of a video image. From the point of view of resolution, the down-sampling may be realized using an MPEG down-sampler or a wavelet down-sampler. From the point of view of frame rate, the down-sampling may be performed using a frame skip method, a frame interpolation method or the like. Down-sampling in accordance with a desired size of a video image refers to a process of adjusting the size thereof so that an original input video image having an aspect ratio of 16:9 can be viewed at an aspect ratio of 4:3. For this purpose, a method of eliminating information corresponding to a boundary region from video information, or a method of reducing the video information to conform to the size of a corresponding screen may be used.

A motion estimation unit 350 may perform motion estimation on the base layer frame, thus obtaining MVs for partitions constituting the base layer frame. Motion estimation is a process of searching for a region that is most similar to the respective partitions of a current frame Fc; that is, a region of a previous reference frame Fr′ stored in a frame buffer 380 where the error is small. Motion estimation may be performed using various methods, such as a fixed size block matching method and a hierarchical variable size block matching method. The previous reference frame Fr′ may be provided from the frame buffer 380. Although the base layer encoder 300 of FIG. 6 may adopt a scheme using the restored frame as a reference frame, that is, a closed-loop encoding scheme, it may additionally or alternatively adopt an open-loop encoding scheme using the original base layer frame, which may be provided by the down-sampler 310, as a reference frame.

Meanwhile, the MVs obtained by the motion estimation unit 350 may be transferred to a virtual region frame generation unit 390. The reason for this is to generate virtual region frames to which virtual regions may be added in the case where the MVs of the boundary region blocks of the current frame are headed for the center of the frame.

A motion compensation unit 360 may perform motion compensation on the reference frame using the obtained MVs. A subtractor 315 may calculate the difference between the current frame Fc of the base layer and the motion-compensated reference frame, thus generating a residual frame.

A conversion unit 320 may perform a spatial transform on the generated residual frame, thus generating transform coefficients. The Discrete Cosine Transform (DCT) or the wavelet transform may be used as the spatial transform method. The transform coefficients are DCT coefficients in the case where the DCT method is employed, and wavelet coefficients in the case where the wavelet transform is employed.

A quantization unit 330 may quantize the transform coefficients generated by the conversion unit 320. Quantization refers to a process of representing the conversion coefficients as discrete values by dividing the conversion coefficients, which are expressed as real numbers, at predetermined intervals, and matching the discrete values to predetermined indices. As described above, the quantized result values are called quantized coefficients.

The entropy encoding unit 340 may encode the transform coefficients, which have been quantized by the quantization unit 330, and MVs, which may be generated by the motion estimation unit 350, without loss, thus generating a base layer bitstream. Various lossless encoding methods, such as an arithmetic encoding method and a variable length encoding method may be used as such a lossless encoding method.

Meanwhile, an inverse quantization unit 371 may dequantize the quantized coefficients output from the quantization unit 330. Such a dequantization process is the inverse of the quantization process and is a process of restoring matched quantization coefficients based on the indices, which have been generated for the quantization process, using a quantization table used in the quantization process.

An inverse conversion unit 372 may perform an inverse spatial transform on the inversely quantized results. The inverse spatial transform is performed in a reverse order relative to the transform process of the conversion unit 320. The Inverse Discrete Cosine Transform (IDCT) or the inverse wavelet transform may be used as such an inverse spatial transform method.

An adder 325 may add the output values of the motion compensation unit 360 and the output values of the inverse conversion unit 372 to restore the current frame (Fc′), and provide the restored frame Fc′ to the frame buffer 380. The frame buffer 380 may temporarily store the restored frame and provide it as a reference frame for the inter-prediction of other base layer frames.

The restored frame Fc′ may be provided to the enhancement layer encoder 400 via an up-sampler 395. The up-sampling process of the up-sampler 395 may be omitted if the resolution of the base layer is identical to that of the enhancement layer.

The construction of the enhancement layer encoder 400 is described below. A frame, which may be provided by the base layer encoder 300, and an input frame may be input to a subtractor 410. The subtractor 210 may calculate the difference between the input frame and the input base layer frame, which may include a virtual region, thus generating a residual frame. The residual frame may be converted into a bitstream via a conversion unit 420, a quantization unit 430, and an entropy encoding unit 440, and may then be output.

The conversion unit 420 of the enhancement layer encoder 400 may perform a spatial transform on the residual signals between the macroblocks of the input frame and the macroblocks of the base layer frame. Here, the DCT or the wavelet transform may be used as the spatial transform method. Due to the characteristics of the macroblocks of the enhancement layer, a similarity exists between the DCT coefficients obtained when DCT is used; the same is true of the wavelet coefficients Accordingly, a process of eliminating the similarity existing between these coefficients and, thereby, increasing the compression rate may be performed by the conversion unit 420 of the enhancement layer encoder 400. In order to increase the compression rate, the Hadamard transform, which has been described in conjunction with FIG. 4, may be employed.

However, a case exists where the similarity of the coefficients of the sub-blocks of each macroblock is low. In this case, it is not necessary to perform a transform process on the transform coefficients. Macroblocks may be constructed using the difference signals between the macroblocks of the base layer frame and macroblocks of the input frame in a manner similar to the temporal inter-prediction.

Since the functions and operations of the quantization unit 430 and the entropy encoding unit 440 may be identical to those of the quantization unit 330 and the entropy encoding unit 340, respectively, the description thereof is omitted.

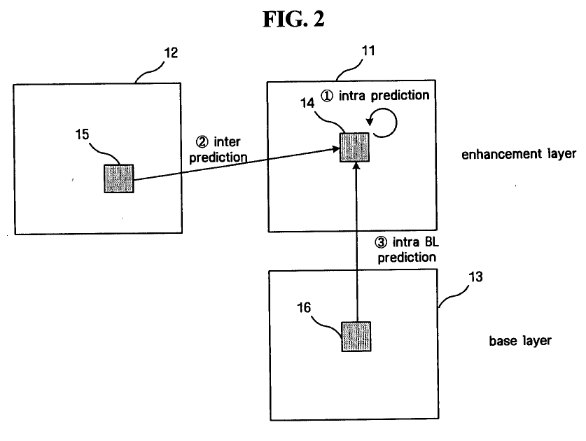

The enhancement layer encoder 400 shown in FIG. 6 has been described with emphasis on the encoding of the results of intra-BL prediction of the base layer frame. In addition, as described in conjunction with FIG. 2, it should be appreciated by those skilled in the art that selective encoding may be performed using a temporal inter-prediction method or a directional intra-prediction method.

FIG. 7 is a block diagram showing the construction of a decoder according to an exemplary embodiment of the present invention. The video decoder 550 may be divided into an enhancement layer decoder 700 and a base layer decoder 600. First, the construction of the base layer decoder 600 is described below.

An entropy decoding unit 610 may decode a base layer bitstream without loss, and extract texture data of a base layer frame and motion data (MVs, partition information, and a reference frame number).

A inverse quantization unit 620 may dequantize the texture data. Such a dequantization process may be the inverse of the quantization process performed in the video encoder 500 Dequantization is a process of restoring quantization coefficients based on the indices, which were generated in the quantization process, using a quantization table used in the quantization process.

An inverse conversion unit 630 may perform an inverse spatial transform on the resulting inversely quantized results, thus restoring a residual frame. The inverse spatial transform may be performed in reverse order to the transform process of the conversion unit 320 of the video encoder 500. As such, the inverse spatial transform method (IDCT) or the inverse wavelet transform may be used.

An entropy decoding unit 610 may provide motion data, including MVs, to a motion compensation unit 660.

The motion compensation unit 660 may perform motion compensation on a previously restored video frame, that is, a reference frame, which may be provided by a frame buffer 650, using the motion data which may be provided by the entropy decoding unit 610, thus generating a motion compensation frame.

An adder 615 may add the residual frame, which may be restored by the inverse conversion unit 630, to the motion compensation frame which may be generated by the motion compensation unit 660, thus restoring the base layer video frame. The restored video frame may be temporarily stored in the frame buffer 650, and may be provided to the motion compensation unit 660 as a reference frame to restore subsequent frames.

A restored frame Fc′, which is restored from a current frame, may be provided to an enhancement layer decoder 700 via an up-sampler 680. Accordingly, the up-sampling process may be omitted if the resolution of the base layer is identical to that of the enhancement layer. Furthermore, the up-sampling process may be omitted if part of the region information is eliminated by the comparison of the video information of the base layer with the video information of the enhancement layer.

The construction of the enhancement layer decoder 700 is described below. When an enhancement layer bitstream is input to an entropy decoding unit 710, the entropy decoding unit 710 may decode the input bitstream without loss, thus extracting the texture data of an asynchronous frame.

Thereafter, the extracted texture data may be restored to the residual frame via a quantization unit 720 and an inverse conversion unit 730. The function and operation of the inverse quantization unit 720 may be identical to those of the inverse quantization unit 620 of the base layer decoder 550.

An adder 715 may add the base layer frame, which is provided by the base layer decoder 600, to the restored residual frame, thus restoring the original frame.

The inverse conversion unit 730 of the enhancement layer decoder 700 may perform an inverse transform based on the method by which the enhanced bitstream of a received macroblock was encoded. The encoding method, as described in conjunction with FIG. 6, may determine whether the step of eliminating the similarity between transform coefficients, such as DCT coefficients or wavelet coefficients, which exist in the sub-blocks of each macroblock, was performed in the process of obtaining the difference using the macroblocks of the base layer frame.

If the step of eliminating the similarity between the coefficients has been included in the encoding process, the inverse process thereof may be performed. As described in conjunction with FIG. 5, the transform coefficients, such as DCT coefficients or wavelet coefficients, may be restored by performing an inverse Hadamard transform, and a macroblock constituted by residual signals may be restored based on the restored coefficients. This process has been described in conjunction with FIG. 5.

The enhancement layer decoder 700 shown in FIG. 7 has been described based on the operation of performing decoding on the base layer frame using intra-BL prediction. In addition, as described in conjunction with FIG. 2, it should be appreciated by those skilled in the art that selective decoding may be performed using an inter-prediction method or an intra-prediction method.

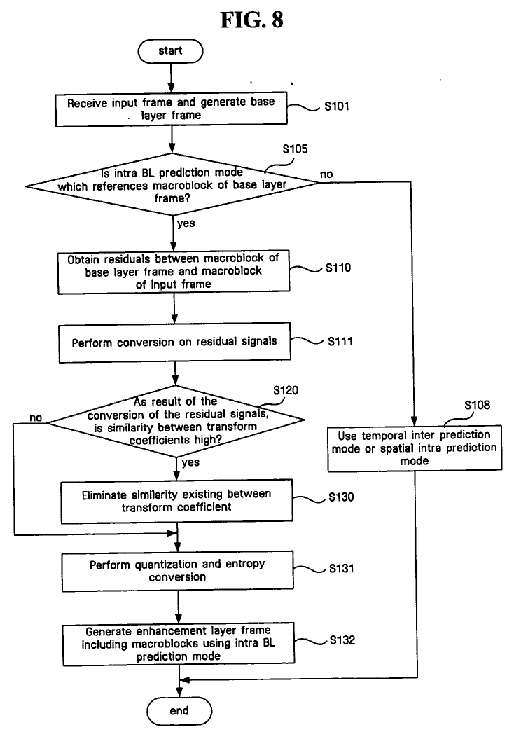

FIG. 8 is a flowchart illustrating a process of encoding a video signal according to an exemplary embodiment of the present invention.

An input frame is received and a base layer frame is generated in S101. When the prediction mode varies on a macroblock basis, it is determined which prediction mode (temporal inter-prediction mode, directional intra-prediction mode, and intra-BL prediction mode) provides the highest compression rate for respective macroblocks. If, as a result, the intra-BL prediction mode is selected in S105, residuals between the corresponding macroblock of the base layer frame and the macroblock of the input frame is obtained in S110. Thereafter, conversion is performed on residual signals in S111. In this case, DCT transform or wavelet transform may be performed. The extent of similarity between transform coefficients obtained by the conversion is determined in S120. If the resolution of the base layer frame is not different from that of the enhancement layer frame, the similarity between the transform coefficients is determined to be high. If the resolution of the base layer frame is different from that of the enhancement layer frame, the similarity therebetween is determined to be low. This is only one embodiment. In S130, the actual correlation between the transform coefficients is obtained, and it is determined that the similarity between the transform coefficient is high when the obtained correlation exceeds a predetermined level. When a similarity exists between the transform coefficients, the similarity is eliminated in S130. In this case, the above-described Hadamard transform may be employed, and the DCT, wavelet transform and Fourier transform are also employed. With respect to operational speed, the Hadamard transform may be faster than the other methods due to the use of addition and subtraction. In the case where the similarity is not high or does not exceed a predetermined level in S120, S131 is directly performed without performing S130. In order to notify a decoding stage of whether the similarity has been eliminated, one bit may be set.

In S131, quantization and entropy processes are performed using the similarity-eliminated transform coefficients and the conversion results obtained in S111. Thereafter, the enhancement layer frame, including macroblocks based on BL prediction, is transferred in S132.

If the intra-BL prediction mode is not used in S105, the temporal inter-prediction mode or spatial intra-prediction mode is used in S108.

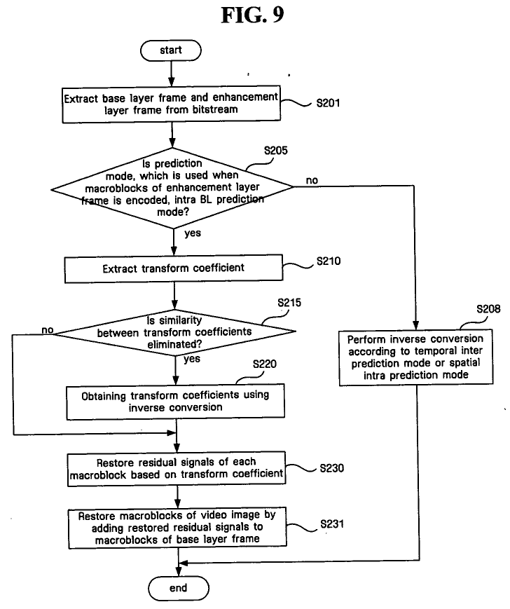

FIG. 9 is a flowchart illustrating a process of decoding a video signal according to an exemplary embodiment of the present invention. First, a base layer frame and an enhancement layer frame are extracted from a received bitstream in S201. It is determined whether intra-BL mode was used as a prediction mode when encoding macroblocks constituting the enhancement layer frame in S205. If the intra-BL prediction mode was not used, inverse transform is performed based on temporal inter-prediction mode or spatial intra-prediction mode in S208. If the intra-BL prediction mode was used, the transform coefficients for the sub-blocks of each macroblock are extracted in S210. Thereafter, it is determined whether the similarity between the transform coefficients has been eliminated in S215. This may be determined using a specific bit as described in conjunction with FIG. 8. Furthermore, the determination may be performed without the specific bit in the case where the similarity between the transform coefficients has been eliminated only when the resolution of the base layer frame is identical to that of the enhancement layer frame. If, as a result, the similarity existing between the transform coefficients has been eliminated, the transform coefficients may be calculated using an inverse transform in S220. In this case, the inverse Hadamard transform, which corresponds to the Hadamard transform performed during encoding, is an example of an inverse transform that may be used. If it is determined that the similarity has not been eliminated in S215, the process proceeds to S230. When the transform coefficients are obtained, the residual signals of each macroblock are restored based on the transform coefficients obtained in S230. The restored residual signals are added to the macroblock of the base layer frame and, thereby, the macroblock of a video image is restored in S231.

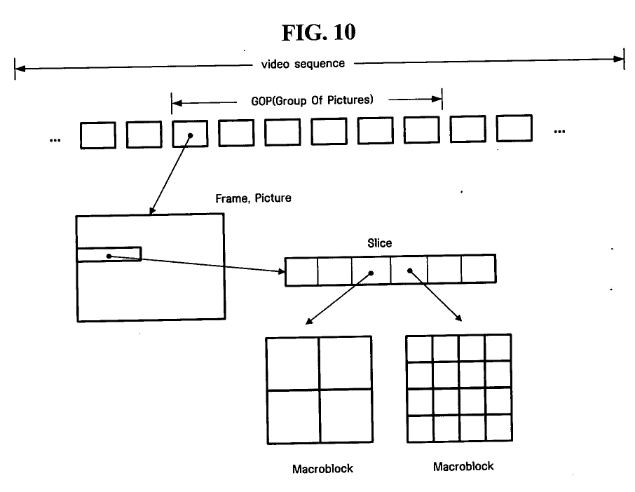

FIG. 10 is an exemplary diagram illustrating a bit set unit for indicating that the method of the present invention is used when intra-BL prediction is performed according to an exemplary embodiment of the present invention.

Video is composed of video sequences. The video sequence is composed of Groups Of Pictures (GOPs), each of which is composed of a plurality of frames (pictures). One frame or picture is composed of a plurality of slices, and each of the slices includes a plurality of macroblocks. For each of the macroblocks, one prediction mode may be selected from three prediction modes, such as directional intra-prediction, temporal inter-prediction and intra-BL prediction. Accordingly, when intra-BL prediction, proposed by an exemplary embodiment of the present invention, is performed, intra-coding may be performed on a macroblock basis. However, if one bit is additionally used to determine whether, on a macroblock basis, intra-coding or inter-coding is performed, many bits may be necessary for the overall frames or the overall slices. Accordingly, the number of bits may be set on a macroblock basis, and the number of bits may also be set on a slice basis or on a frame basis. As shown in FIG. 10, the number of bits may be set on a macroblock basis. Furthermore, one bit may be set for all the macroblocks constituting a corresponding slice. In this case, information requirements can be reduced because one bit is assigned to each slice.

In accordance with the present invention, a compression rate may be increased by eliminating the similarity that exists between the pieces of information of the sub-blocks of each macroblock to be encoded using intra-BL prediction.

Furthermore, by implementing the present invention, the compression rate may be increased by applying an intra-prediction method when video information is compressed using an intra-BL mode and, therefore, the amount of data transmitted over a network may be reduced.

The exemplary embodiments of the present invention have been disclosed for illustrative purposes, and those skilled in the art will appreciate that various modifications, additions and substitutions are possible, without departing from the scope and spirit of the invention as disclosed in the accompanying claims.

What is claimed is:

1. A method of encoding video signals in intra-Base-Layer (BL) prediction mode by selectively applying intra-coding in a multilayer-based video encoder, the method comprising:
(a) calculating a difference between an input frame and a base layer frame calculated from the input frame and obtaining residual signals;
(b) converting the residual signals using an intra-coding method; and
(c) generating an enhancement layer frame including the converted residual signals.

2. The method of claim 1, wherein (a) comprises calculating a difference between a first macroblock constituting part of the input frame, and a second macroblock constituting part of the base layer frame and corresponding to the first macroblock, and obtaining the residual signals.

3. The method of claim 1, wherein (b) comprises converting second sub-blocks of a macroblock by referring to first sub-blocks constituting a macroblock formed of the residual signals.

4. The method of claim 1, wherein (b) comprises (d) converting transform coefficients of a plurality of sub-blocks constituting a macroblock constructed by the residual signals.

5. The method of claim 4, wherein (d) converts the transform coefficients using a Hadamard transform.

6. The method of claim 4, further comprising, after (b), (e) setting information indicating that the residual signals have been converted using an intra-coding method.

7. The method of claim 6, wherein (e) sets the information on a macroblock basis.

8. The method of claim 6, wherein (e) sets information about all blocks included in each slice.

9. The method of claim 6, wherein (e) sets information about all macroblocks included in each frame.

10. The method of claim 1, further comprising comparing results converted using an intra-coding method with results converted using an inter-coding method.

11. A method of encoding video signals in intra-Base-Layer (BL) prediction mode by selectively applying intra-coding in a multilayer-based video encoder, the method comprising:
(a) calculating a difference between an input frame and a base layer frame calculated from the input frame and obtaining residual signals;
(b) determining if resolution of the base layer frame is identical to that of the enhancement layer frame and converting the residual signals using an intra-coding method if the resolution is identical;
(c) generating an enhancement layer frame including the converted residual signals; and
(d) comparing results converted using an intra-coding method with results converted using an inter-coding method.

12. A method of decoding video signals in intra-BL prediction mode by selectively applying intra-coding in a multilayer-based video decoder, the method comprising:
(a) receiving a base layer frame and an enhancement layer frame;
(b) performing an inverse transform when residual signals of the enhancement layer frame are encoded using an intra-coding method; and
(c) performing restoration by adding the inversely transformed residual signals to image signals of the base layer frame.

13. The method of claim 12, wherein (b) comprises:
restoring transform coefficients existing in the residual signals; and
restoring the residual signals using restored transform coefficients.

14. The method of claim 12, wherein (b) comprises:
restoring transform coefficients of a plurality of sub-blocks constituting a macroblock formed of the residual signals; and
restoring the sub-blocks using the restored transform coefficients.

15. The method of claim 14, further comprising (d) restoring the transform coefficients using an inverse Hadamard transform.

16. The method of claim 12, further comprising, before (b), extracting information indicating that residual signals have been converted using an intra-coding method.

17. The method of claim 16, wherein the information is information set on a macroblock basis.

18. The method of claim 16, wherein the information is information set for all macroblocks included in each slice.

19. The method of claim 16, wherein the information is information set for all macroblocks included in each frame.

20. A method of decoding video signals in intra-BL prediction mode by selectively applying intra-coding in a multilayer-based video decoder, the method comprising:
(a) receiving a base layer frame and an enhancement layer frame;
(b) determining if resolution of the base layer frame is identical to that of the enhancement layer frame and performing an inverse transform when residual signals of the enhancement layer frame are encoded using an intra-coding method if the resolution is identical; and
(c) performing restoration by adding the inversely transformed residual signals to image signals of the base layer frame.

21. An encoder comprising:
a base layer encoder generating a base layer frame from an input frame; and
an enhancement layer encoder generating an enhancement layer frame from the input frame;
wherein, at a time of generating a macroblock of the enhancement layer frame, the enhancement layer encoder comprises a conversion unit performing intra-coding on residual signals obtained by calculating a difference between a macroblock of the base layer frame, which corresponds to the macroblock of the enhancement layer frame, and a macroblock of the input frame.

22. The encoder of claim 21, wherein the conversion unit converts a second sub-block, which is part of a macroblock, by referring to a first sub-block constituting part of a macroblock that is formed of the residual signals.

23. The encoder of claim 21, wherein the conversion unit converts transform coefficients of sub-blocks constituting the macroblock that is formed of the residual signals.

24. The encoder of claim 23, wherein the conversion unit converts the transform coefficients using a Hadamard transform.

25. The encoder of claim 21, wherein the conversion unit sets information indicating that the residual signals have been converted using an intra-coding method.

26. The encoder of claim 25, wherein the information is information set on a macroblock basis.

27. The encoder of claim 25, wherein the information is information set for all macroblocks included in each slice.

28. The encoder of claim 25, wherein the information is information set for all macroblocks included in each frame.

29. The encoder of claim 21, wherein the conversion unit compares results encoded using an intra-coding method with results encoded using an inter-coding method.

30. The encoder of claim 29, wherein the conversion unit determines whether resolution of the base layer frame is identical to that of the enhancement layer frame, and performs intra-coding on the residual signals if the resolution is identical.

31. A decoder comprising:
a base layer decoder for restoring a base layer frame; and
an enhancement layer decoder for restoring an enhancement layer frame;
wherein the enhancement layer decoder performs an inverse transform on residual signals and performs restoration by adding inversely transformed residual signals to image signals of the restored base layer frame, thus restoring the image signals when the residual signals are encoded using an intra-coding method.

32. The decoder of claim 31, wherein an inverse conversion unit restores transform coefficients existing in the residual signals, and restores the residual signals using the restored transform coefficients.

33. The decoder of claim 31, wherein an inverse conversion unit restores transform coefficients of a plurality of sub-blocks constituting a macroblock formed of the residual signals, and restores the sub-blocks using the restored transform coefficients.

34. The decoder of claim 33, wherein the inverse conversion unit converts the transform coefficients using an inverse Hadamard transform.

35. The decoder of claim 31, wherein the enhancement layer decoder extracts information indicating that the residual signals have been converted using an intra-coding method.

36. The decoder of claim 35, wherein the information is information set on a macroblock basis.

37. The decoder of claim 35, wherein the information is information set for all macroblocks included in each slice.

38. The decoder of claim 35, wherein the information is information set for all macroblocks included in each frame.

39. The decoder of claim 31, wherein an inverse conversion unit determines whether resolution of the base layer frame is identical to that of the enhancement layer frame, and restores the residual signals by performing an inverse transform if the resolution is identical.

40. A computer readable medium having stored therein a program for encoding video signals in intra-Base-Layer (BL) prediction mode by selectively applying intra-coding in a multilayer-based video encoder, said program including computer executable instructions for performing steps comprising:
(a) calculating a difference between an input frame and a base layer frame calculated from the input frame and obtaining residual signals;
(b) converting the residual signals using an intra-coding method; and
(c) generating an enhancement layer frame including the converted residual signals.

41. A computer readable medium having stored therein a program for encoding video signals in intra-Base-Layer (BL) prediction mode by selectively applying intra-coding in a multilayer-based video encoder, said program including computer executable instructions for performing steps comprising:
(a) calculating a difference between an input frame and a base layer frame calculated from the input frame and obtaining residual signals;
(b) determining if resolution of the base layer frame is identical to that of the enhancement layer frame and converting the residual signals using an intra-coding method if the resolution is identical;
(c) generating an enhancement layer frame including the converted residual signals; and
(d) comparing results converted using an intra-coding method with results converted using an inter-coding method.

42. A computer readable medium having stored therein a program for decoding video signals in intra-BL prediction mode by selectively applying intra-coding in a multilayer-based video decoder, said program including computer executable instructions for performing steps comprising:
(a) receiving a base layer frame and an enhancement layer frame;
(b) performing an inverse transform when residual signals of the enhancement layer frame are encoded using an intra-coding method; and
(c) performing restoration by adding the inversely transformed residual signals to image signals of the base layer frame.

43. A computer readable medium having stored therein a program for decoding video signals in intra-BL prediction mode by selectively applying intra-coding in a multilayer-based video decoder, said program including computer executable instructions for performing steps comprising:
(a) receiving a base layer, frame and an enhancement layer frame;
(b) determining if resolution of the base layer frame is identical to that of the enhancement layer frame and performing an inverse transform when residual signals of the enhancement layer frame are encoded using an intra-coding method if the resolution is identical; and
(c) performing restoration by adding the inversely transformed residual signals to image signals of the base layer frame.
